(19) United States
(12) Patent Application Publication
(10) Pub. No.: US 2018/0060991 A1
(43) Pub. Date: Mar. 1, 2018

(54) PLACEMENT SYSTEM FOR MOBILE OBJECTS

(71) Applicant: DENA CO., LTD., Tokyo (JP)

(72) Inventor: Hironari YASHIRO, Tokyo (JP)

(73) Assignee: DeNa Co., Ltd.

(21) Appl. No.: 15/682,450

(22) Filed: Aug. 21, 2017

(30) Foreign Application Priority Data
Aug. 23, 2016 (JP) 2016-162720

(51) Int. Cl. G06Q 50/30

(52) U.S. Cl. CPC G06Q 50/30

(57) ABSTRACT

A placement system for mobile objects accesses a storage means for storing dispatch information related to factors that influence the dispatch of vehicles in association with locations on a map, displays a map on a user terminal, receives the input of a location on the map, refers to dispatch information and determines dispatch candidate locations that are candidates for dispatching a vehicle on the basis of their location on the map, and displays dispatch candidate locations on the map.

### CROSS REFERENCE TO RELATED APPLICATIONS

This Paris Convention Patent Application claims benefit under 35 U.S.C. §119 and claims priority to Japanese Patent Application No. JP 2016-162720, filed on Aug. 23, 2016, the content of which is incorporated herein in its entirety by reference for all purposes.

### BACKGROUND

### Field

The present invention relates to a placement system for mobile objects, and more specifically for designating a vehicle dispatch site from a user terminal.

### Related Art

Conventionally, when an individual wants to call a taxi, he generally uses a telephone (land line or mobile phone) to talk to the nearest branch of the taxi company and convey his location so that a car can be sent.

There has also been disclosed a system in which a customer terminal such as a smart phone, a taxi dispatch center, and a taxi terminal are connected via a communication network, a map that combines location information about the customer terminal and the taxi terminal is sent to the customer terminal, and a taxi is selected on the customer terminal so that information about the location of the customer (terminal) is conveyed to the selected taxi (Patent Document 1). There has also been disclosed a system in which a dispatch location can be designated by a customer by designating some location on a map (Non-Patent Document 1).

### PRIOR ART DOCUMENTS

### Patent Document

Patent Document 1: Japanese Patent Application 2004-110758

### Non-Patent Document

Non-Patent Document 1: Uber (www.uber.com/ja/ride/)

### SUMMARY

### Problems to be Solved by the Invention

With such a conventional dispatch system, however, there is the risk that the location designated on the map by a customer will be a location where vehicles are prohibited from entering, or where there is no parking, which would prevent a vehicle from being dispatched to the designated location.

It is an object of the present invention to provide a placement system for mobile objects with which a customer can easily designate a vehicle dispatch location according to a variety of conditions.

### Means for Solving the Problems

One aspect of the present invention is a placement system for mobile objects comprising a user terminal used by a user and a host computer connected so as to be able to exchange information with the user terminal, said system further comprising storage means for storing dispatch information related to factors that influence the dispatch of mobile objects in association with locations on a map;

map display means for displaying the map on the user terminal; location information acquisition means for receiving the input of a location on the map from the user terminal; dispatch candidate location determination means for referring to the location information and determining dispatch candidate locations that are candidates for dispatching a mobile object on the basis of their location on the map inputted by the location information acquisition means; and dispatch candidate location display means for displaying the dispatch candidate locations on the map displayed on the user terminal.

Another aspect of the present invention is a user terminal comprising map display means for displaying a map; location information acquisition means for receiving the input of a location on the map; dispatch candidate location determination means for referring to dispatch information that influences the dispatch of mobile objects in association with locations on the map, and determining dispatch candidate locations that are candidates for dispatching a mobile object on the basis of their location on the map inputted by the location information acquisition means; and dispatch candidate location display means for displaying the dispatch candidate locations on the map.

Another aspect of the present invention is a vehicle dispatch program that causes a computer, which can access a storage means for storing dispatch information that influences the dispatch of vehicles in association with locations on a map (e.g., non-transitory computer readable medium having instructions for performing dispatch of vehicles, including a processor and a storage configured to store dispatch information that influences the dispatch of vehicles in association with locations on a map), to function as map display means for displaying a map; location information acquisition means for receiving the input of a location on the map; dispatch candidate location determination means for referring to dispatch information that influences the dispatch of vehicles in association with locations on the map, and determining dispatch candidate locations that are candidates for dispatching a vehicle on the basis of their location on the map inputted by the location information acquisition means; and dispatch candidate location display means for displaying the dispatch candidate locations on the map.

Here, it is preferable if there are provided dispatch location information acquisition means for receiving from the user terminal a designation of a vehicle dispatch location from the map on which the dispatch candidate locations are displayed; and vehicle dispatch means for dispatching a vehicle to the dispatch location.

Also, it is preferable if the dispatch information includes at least one of the following: road conditions, environment information, traffic information, weather information, and information about the vehicles themselves. It is also preferable if the dispatch information includes information obtained from the dispatch locations designated in the past. It is also preferable if the dispatch information is changed according to the time of day.

It is also preferable if the dispatch location information acquisition means receives a designation of the travel direction of a vehicle at the dispatch location, and the vehicle dispatch means sends information about the travel direction to the vehicle.

Effects of the Invention

The present invention provides a placement system for mobile objects with which a customer can have a vehicle dispatched to a suitable location according to a variety of conditions.

### BRIEF DESCRIPTION OF THE DRAWINGS

FIG. 1 illustrates a diagram of the configuration of a placement system for mobile objects in an embodiment of the present invention.

FIG. 2 illustrates a diagram of the configuration of a host computer in an embodiment of the present invention.

FIG. 3 illustrates diagram of the configuration of a user terminal in an embodiment of the present invention.

FIG. 4 illustrates a flowchart of vehicle dispatch processing in an embodiment of the present invention.

FIG. 5 illustrates an example of a map database in an embodiment of the present invention.

FIG. 6 illustrates an example of dispatch information in an embodiment of the present invention.

FIG. 7 illustrates an example of dispatch information in an embodiment of the present invention.

FIG. 8 illustrates a display example of a map in an embodiment of the present invention.

FIG. 9 illustrates processing for determining dispatch candidate locations in an embodiment of the present invention.

FIG. 10 illustrates a display example of a map and the dispatch candidate locations in an embodiment of the present invention.

FIG. 11 illustrates an example of a dispatch location database in an embodiment of the present invention.

FIG. 12 illustrates an example of displaying the orientation of a vehicle in an embodiment of the present invention.

FIG. 13 illustrates an example of a dispatch location history database in an embodiment of the present invention.

### DETAILED DESCRIPTION

As shown in FIG. 1, a placement system for mobile objects 100 in an embodiment of the present invention is configured to include a host computer 102 (e.g., a server) and a user terminal 104. The host computer 102 and the user terminal 104 are connected via an information communication network 106 (such as the Internet) in a state in which information transmission is possible. The placement system for mobile objects 100 is also connected to a mobile object 108 via the information communication network 106. There are no particular restrictions on the information communication network 106 as long as it allows information to be transmitted, and it may be a wired communication network or a wireless communication network.

The placement system for mobile objects 100 receives from the user terminal 104 the designation of the location to which a vehicle is to be moved (dispatch location) and performs processing to transmit the dispatch location that will be the destination of the mobile object 108 from the host computer 102.

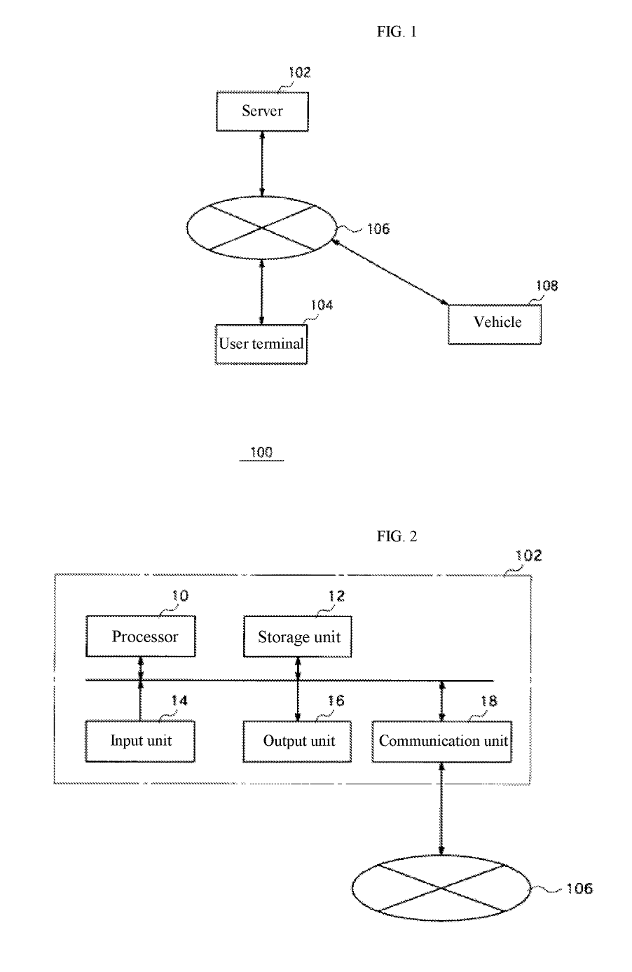

As shown in FIG. 2, the host computer 102 is configured to include a processor 10, a storage unit 12, an input unit 14, an output unit 16, and a communication unit 18. The processor 10 includes a means for performing arithmetic processing, such as a CPU. The processor 10 executes a host program (e.g., non-transitory computer readable medium having instructions for performing dispatch of vehicles, including a processor and a storage configured to store dispatch information that influences the dispatch of vehicles in association with locations on a map) stored in the storage unit 12 and thereby performs functions such as providing a map and dispatch information to the user terminal 104 and acquiring dispatch location information from the user terminal 104 and transmitting it to the mobile object 108 in the placement system for mobile objects 100 in this embodiment. The storage unit 12 includes a storage means such as a semiconductor memory or a memory card. The storage unit 12 is accessibly connected to the processor 10, and stores a host program and information that is required for the processing of this program. The input unit 14 includes a means for inputting information. The input unit 14 comprises, for example, a keyboard, a touch panel, buttons, or the like for receiving input from an administrator. The output unit 16 includes a means for outputting the result of processing by the host computer 102, such as a user interface screen (UI) for receiving input information from the administrator. The output unit 16 comprises, for example, a display for displaying images to the administrator. The communication unit 18 is configured to include an interface that shares information with the user terminal 104 via the information communication network 106. Communication with the communication unit 18 may be wired or wireless.

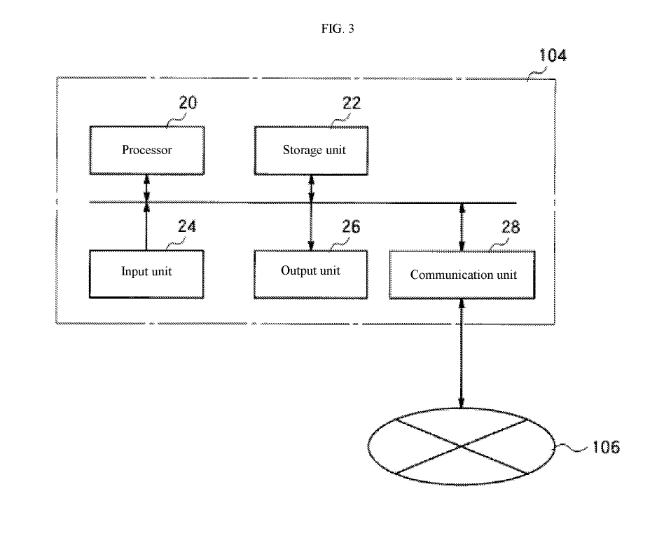

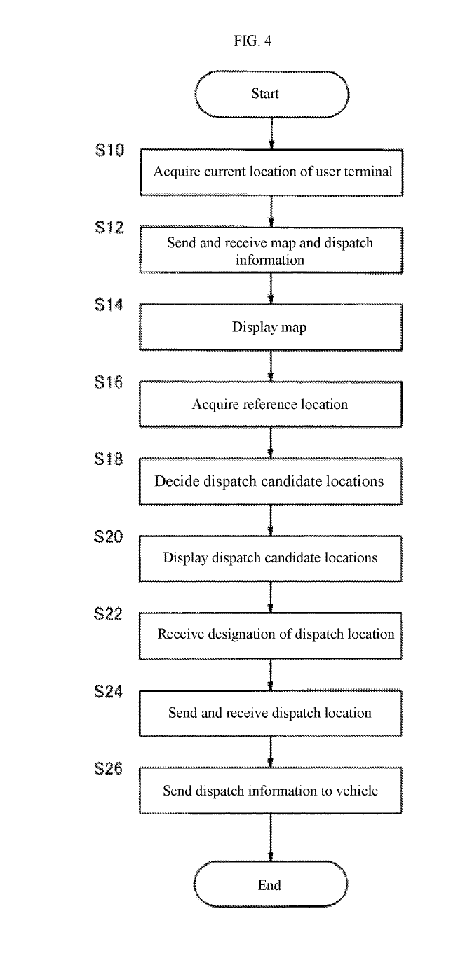

As shown in FIG. 3, the user terminal 104 is configured to include a processor 20, a storage unit 22, an input unit 24, an output unit 26, and a communication unit 28. The processor 20 includes a means for performing arithmetic processing, such as a CPU. The processor 20 executes a client program (e.g., non-transitory computer readable medium having instructions for performing dispatch of vehicles, including a processor and a storage configured to store dispatch information that influences the dispatch of vehicles in association with locations on a map) stored in the storage unit 22, and thereby performs the functions of the user terminal 104 in this embodiment. The processor 20 preferably comprises a means for specifying the location of the user terminal 104. For example, the processor 20 preferably comprises a location specification means that makes use of a global positioning system (GPS) or a wireless network base station. The storage unit 22 includes a storage means such as a semiconductor memory or a memory card. The storage unit 22 is accessibly connected to the processor 20 and stores a client program and information that is required for the processing of this program. The input unit 24 includes a means for inputting information. The input unit 24 comprises, for example, a keyboard, a touch panel, buttons, or the like for receiving input from a user. The output unit 26 includes a means for outputting the information that is required for the processing by the user terminal 104, such as a user interface screen (UI) or a screen displaying posted information, in order to receive input information from the user. The output unit 26 comprises, for example, a display for displaying images to the user. The communication unit 28 is configured to include an interface that shares information with the host computer 102 via the information communication network 106. Communication with the communication unit 28 may be wired or wireless.

The mobile object 108 has a means for moving the area included in the map (discussed below). The mobile object 108 can be, for example, a vehicle that drives on a road. More specifically, the mobile object 108 can be a taxi or a cargo delivery vehicle, for example.

The vehicle dispatch processing in this embodiment will now be described through reference to the flowchart of FIG. 4. The following processing is accomplished by having the host computer 102 execute the host program and having the user terminal 104 execute the client program. In the present embodiment, a vehicle (e.g. a car) is an example of the mobile object 108, however the mobile object 108 does not have to be a vehicle, and other mobile objects (e.g., drones) may also be utilized depending on the desired implementation. In the following description the placement location of the moving body 108 will therefore be described as the vehicle dispatch location.

In step S10, an instruction to start vehicle dispatch processing is sent from the user terminal 104. The user uses the input unit 24 of the user terminal 104 to issue an instruction to start the processing in the placement system for mobile objects 100. For example, an instruction to start vehicle dispatch processing by accessing the URL of the web site that provides the placement system for mobile objects 100 is received. When the processor 20 of the user terminal 104 receives an instruction to start vehicle dispatch processing, user terminal location information indicating the current location of the user terminal 104 is sent to the host computer 102 along with the start instruction via the communication unit 28. The user terminal location information can be acquired by a location recognition technique featuring a wireless base station accessed by the user terminal 104, or a GPS function provided to the user terminal 104. For example, the current location of the user terminal 104 may be the latitude and longitude of the user terminal 104. If the mobile object 108 is a flying object capable of moving through the air, the current location of the user terminal 104 may include altitude in addition to latitude and longitude. Vehicle dispatch processing is commenced when the processor 10 of the host computer 102 receives the vehicle dispatch processing start instruction and the user terminal location information via the communication unit 18.

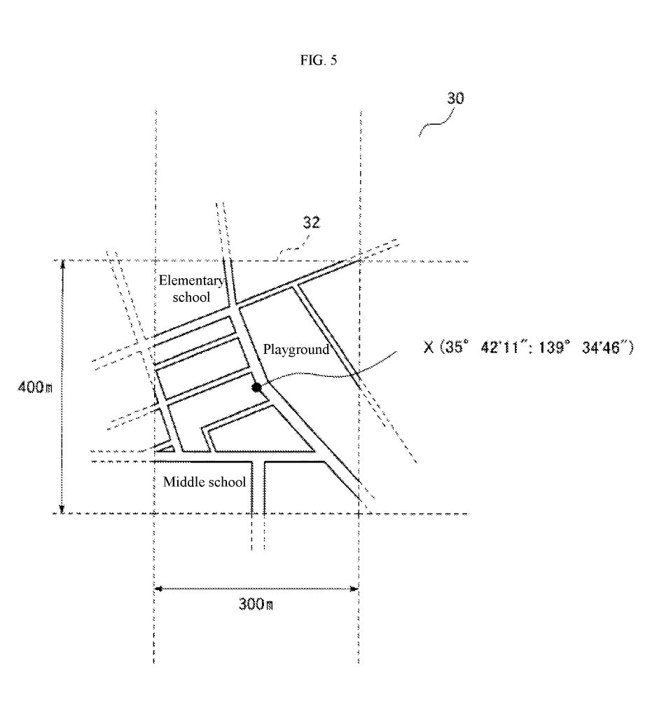

In step S12, a map is transmitted from the host computer 102 to the user terminal 104. The processing in this step causes the host computer 102 to function as a map transmission means, and the user terminal 104 to function as a map reception means. As shown in FIG. 5, a map database 30 may be stored in advance in the storage unit 12. The processor 10 of the host computer 102 refers to the user terminal location information indicating the current location X of the user terminal 104 received in step S10 and chooses a map 32 covering a specific range around the current location X from the map database registered in the storage section 12.

FIG. 5 shows an example of choosing a map 32 when the current location X is at a latitude of 35° 42′ 11″ N and a longitude of 139° 34′ 46″ E. In this example, a map 32 is chosen that covers a range of 400 m in the latitude direction and 300 m in the longitude direction, with the current location X as the center location. However, the chosen range of the map 32 is not limited to this, and the configuration may allow the user to specify the range, or the range may be changed according to the configuration of the placement system for mobile objects 100.

The processor 10 chooses dispatch information related to factors that that influence the dispatch of vehicles in association with locations on a map. In this embodiment, since the vehicle is a road-going vehicle, the dispatch information is road conditions related to the vehicle. Specific examples include dispatch information indicating locations where vehicles are prohibited from entering (no-entry locations) and information indicating locations vehicles are prohibited from stopping (no-parking locations). However, the dispatch information is not limited to this, and other examples will be given below.

Dispatch information is stored in the storage unit 12 in association with the map. For example, the dispatch information is registered in association with coordinates on the map or with areas on the map. The coordinates on the map can be latitude and longitude if the vehicle is one that moves over the ground. If the vehicle is one that can move through the air, such as an aircraft, altitude may be included in addition to latitude and longitude. Also, an area on the map can be a road area, a zoned area, a flight area, or the like.

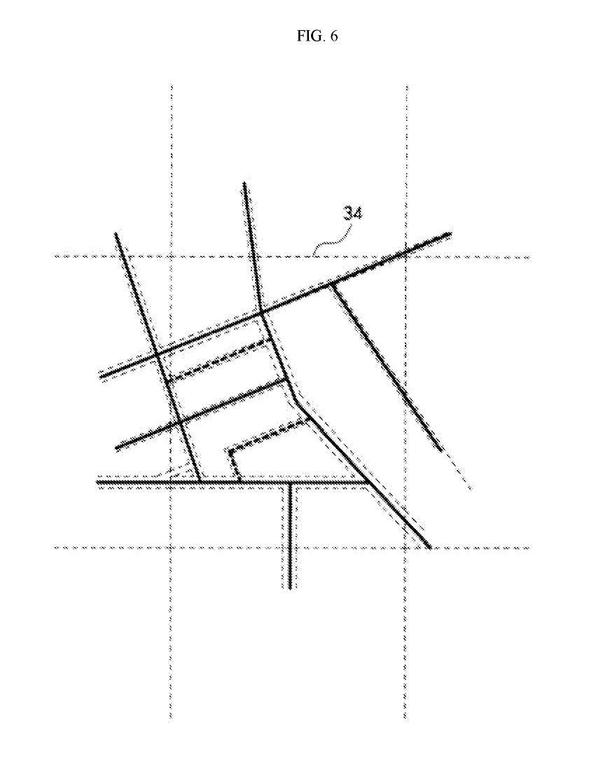

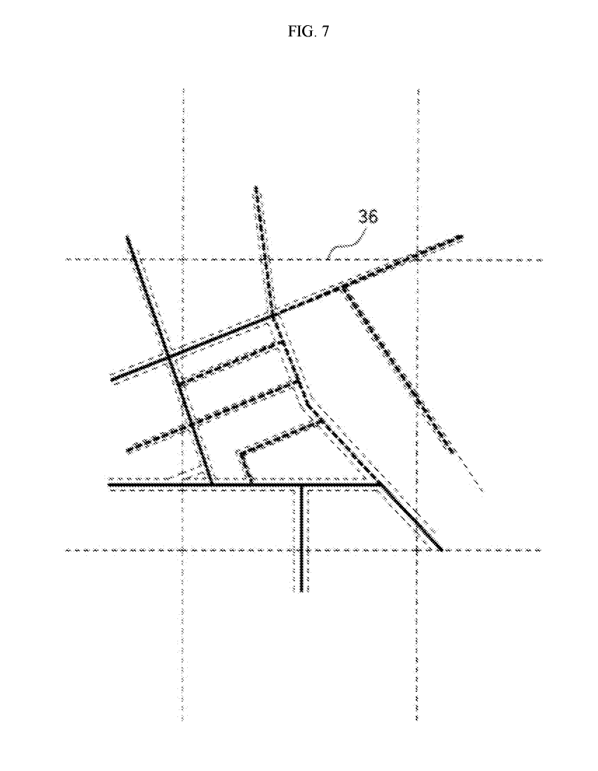

In this embodiment, since the vehicle is a road-going vehicle, an example will be given in which the dispatch information is registered in association with a road area on the map. If the dispatch information is a location where vehicles are prohibited from entering (no-entry location), as shown in FIG. 6, information (dispatch information 34) indicating road areas where vehicles can enter (indicated by a thick solid line in the drawing) and road areas where vehicles cannot enter (indicated by a thick broken line in the drawing) is stored in the storage unit 12 in association with the road area on the map. If the dispatch information indicates locations where vehicles are prohibited from stopping (no-parking locations), as shown in FIG. 7, information (dispatch information 36) indicating road areas where vehicles can stop (indicated by a thick solid line in the drawing) and road areas where vehicles cannot stop (indicated by a thick broken line in the drawing) is stored in the storage unit 12 in association with the road area on the map.

The processor 10 refers to the dispatch information stored in the storage unit 12 and chooses the dispatch information 34 and 36 within the range of the map 32 chosen on the basis of the current location X of the user terminal 104. The processor 10 sends the chosen map 32 and the dispatch information 34 and 36 through the communication unit 18 to the user terminal 104. The user terminal 104 receives the map 32 and the dispatch information 34 and 36 via the communication unit 28.

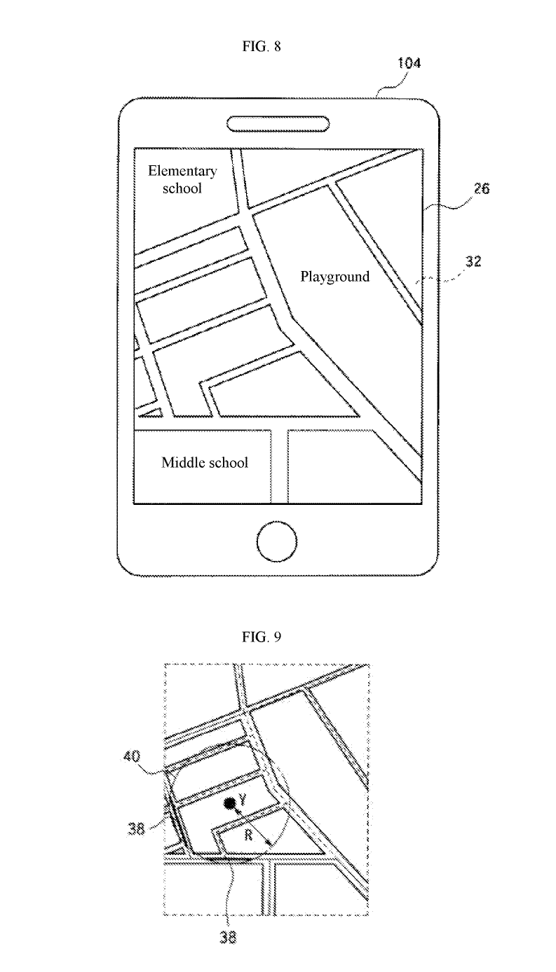

In step S14, a map is displayed on the user terminal 104. The processing in this step causes the user terminal 104 to function as a map display means. As shown in FIG. 8, the processor 20 of the user terminal 104 displays a map on the output unit 26 on the basis of the map 32 received in step S12.

In step S16, processing is performed for receiving the input of a location on the map from the user terminal 104. The processing in this step causes the user terminal 104 to function as a location information acquisition means. The user uses the input unit 24 of the user terminal 104 to input the location serving as a reference for the dispatch of a vehicle on the map displayed on the output unit 26 in step S14. For example, if the input unit 24 is a touch panel, the reference location is inputted by touching the map displayed on the output unit 26 with a finger. Also, if the input unit 24 is a pointing device such as a mouse, for example, the reference location is inputted by moving the cursor on the map displayed on the output unit 26 and clicking. The processor 20 receives the input of the reference location.

In this embodiment, the processing involved receiving the designation of a reference location from the user, but the present invention is not limited to or by this. For example, the current location X of the user terminal 104 may be used as the reference location.

In step S18, processing for determining dispatch candidate locations that are candidates for dispatching vehicles is performed on the basis of the inputted reference location, by referring to the dispatch information 34 and 36. The processing in this step causes the user terminal 104 to function as a dispatch candidate location determination means. The processor 20 refers to the dispatch information 34 and 36 received in step S12 and determines the dispatch candidate locations for vehicles on the basis of the reference location whose input was received in step S16.

For example, as shown in FIG. 9, an area where vehicles can enter and vehicles can also stop within a specific range 40 (such as within a range of a radius R) from a reference location Y is determined as a dispatch candidate location 38 (indicated by a thick solid line in the drawing). However, the processing for determining the dispatch candidate locations is not limited to this. For example, an area where vehicles can enter within a specific range from the reference location Y may be determined as a dispatch candidate location by referring to only the dispatch information 34. Also, an area where vehicles can stop within a specific range from the reference location Y may be determined as a dispatch candidate location by referring to only the dispatch information 36.

The specific range from the reference location Y is not limited to the range of the radius R.

For example, the specific range may be a rectangular area comprising a specific distance in the longitude direction and a specific distance in the latitude direction, with the reference location Y at the center. Also, if the vehicle is one that can move through the air, such as an aircraft, the specific range may be defined to include a range in altitude in addition to the latitude and longitude. Also, a specific range can be set with respect to the reference location Y via input from the user.

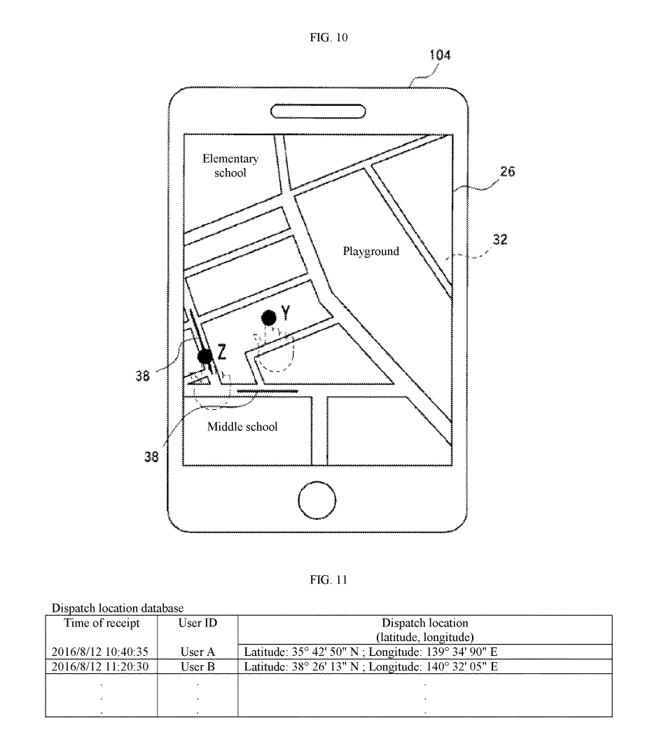

In step S20, processing is performed for displaying the dispatch candidate locations on the user terminal 104. The processing in this step causes the user terminal 104 to function as a dispatch candidate location display means. The processor 20 displays the dispatch candidate locations found in step S18 on the output unit 26. At this point, as shown in FIG. 10, it is preferable to display the dispatch candidate locations superimposed over the map displayed on the output unit 26 in step S14.

In addition to changing the designation of the reference location Y on the map, the user may also choose and display the dispatch candidate locations 38 in real time. Specifically, by repeating the processing from steps S16 to S20, every time the reference location Y is changed, the dispatch candidate locations 38 corresponding to the changed reference location Y may be found and displayed.

In step S22, processing is performed for receiving the designation of the dispatch location of the mobile object 108 from the user terminal 104. The processing in this step causes the user terminal 104 to function as a dispatch location information acquisition means. The processor 20 uses the input unit 24 to receive a designation about where the user wants the mobile object 108 to be dispatched (dispatch location), from the dispatch candidate locations 38 on the map displayed on the output unit 26 in step S20. For example, if the input unit 24 and the output unit 26 are touch panels, the user taps a finger on a dispatch candidate location 38 on the displayed map as shown in FIG. 10, and the tapped location is received as the dispatch location Z of the mobile object 108. The processor 20 sends the host computer 102 the dispatch location Z received via the communication unit 28, along with a user ID that identifies the user who designated it. The host computer 102 receives the dispatch location Z and the user ID via the communication unit 18.

In step S24, information about the dispatch location Z is sent from the host computer 102 to the mobile object 108. The processing in this step causes the host computer 102 to function as a vehicle dispatch means. When the processor 10 of the host computer 102 receives the dispatch location Z sent via the communication unit 18 from the user terminal 104, as shown in FIG. 11, the dispatch location Z is associated with the receipt time and the user ID that identifies the user who designated the dispatch location Z, and is stored in the storage unit 12. The processor 10 also sends information indicating the dispatch location Z to the mobile object 108 via the communication unit 18. Consequently, the mobile object 108 that has received the dispatch location Z can be moved to the dispatch location Z.

For example, if the mobile object 108 is a taxi, the current locations of taxis registered to the host computer 102 are collected, an empty taxi that is near the dispatch location Z is selected, and the dispatch location Z is sent to that taxi. The current location of the mobile object 108 may be sent to the host computer 102 via a GPS or other such location recognition means installed in the mobile object 108. This allows the driver of the taxi that received the dispatch location Z to move the vehicle to the dispatch location Z.

For example, if the mobile object 108 is a delivery vehicle that delivers cargo to the user who designated the dispatch location Z, the delivery vehicle that is loaded with the user's cargo may be chosen, and the dispatch location Z sent to the chosen delivery vehicle. More specifically, a delivery vehicle loaded with cargo to be delivered to a user is registered in the storage unit 12 in association with a user ID that identifies that user, and the delivery vehicle associated with the received user ID is chosen by referring to that user ID, along with the dispatch location Z received in step S22 by the processor 10.

The processor 10 then sends the dispatch location Z to the chosen delivery vehicle. Consequently, the driver of the delivery vehicle that has received the dispatch location Z is able to move the delivery vehicle to the dispatch location Z. Therefore, the user can receive the cargo at the dispatch location Z.

This embodiment can also be applied to a mobile object 108 that operates autonomously. With an autonomously operated mobile object 108, the mobile object 108 that has received a dispatch location is automatically moved to and stopped at that dispatch location by autonomous operation technology. Also, the mobile object 108 is not limited to a road-going vehicle, and may be any vehicle that moves on the basis of a map (including nautical and aerial charts, etc.). For example, the mobile object 108 may be an aircraft (such as a drone), a ship, or the like.

As discussed above, with this embodiment, it is possible to designate a dispatch location on the basis of the dispatch information related to the dispatch of a vehicle on a map. This makes it possible to designate the dispatch location of the vehicle, excluding, for example, areas where vehicles are prohibited from entering or areas where vehicles are prohibited from stopping.

The dispatch information is not limited to the above example. For instance, the dispatch information may be road conditions. Road conditions can include locations where the mobile object 108 cannot enter or locations where the mobile object 108 cannot stop, as well as information related to the transit of the mobile object 108 (number of lanes, one-way streets, and other such information).

When the number of lanes, as information related to the transit of the mobile object 108, is utilized as the dispatch information, a road in which the number of lanes within a specific range from the reference location Y is greater than or less than a specific number may be determined as a dispatch candidate location and presented to the user. When information related to a one-way street, as information related to the transit of the mobile object 108, is utilized as the dispatch information, a road in which a vehicle can pass in a specific direction within a specific range from the reference location Y may be determined as a dispatch candidate location and presented to the user. For example, in Japan where vehicles drive on the left side of the road, an area where a vehicle moves close to the reference location Y from the left side may be presented as a dispatch candidate location.

Also, the dispatch information may be information related to the environment registered in association with the location information of the map. For example, information related to the environment can be information related to the characteristics of the locale (a residential area, a commercial area, an industrial area, an area related to education, etc.). For example, processing may be performed so that a residential area within a specific range from the reference location Y is determined to be a dispatch candidate location, while a commercial area or industrial area is determined not to be a dispatch candidate location, or vice versa. Thus, the dispatch location of the mobile object 108 can be easily designated by designating or excluding any areas having a particular characteristic. Also, information related to the environment and other dispatch information may be used in combination. For instance, the processing may be such that a location that can be entered by the mobile object 108 and is not in an area related to education (schools and their surroundings, etc.) may be determined as a dispatch candidate location and presented to the user. This makes it easy to designate the dispatch location of the mobile object 108 while excluding areas related to education. Information related to the environment may be information related to sidewalks. For example, roads in which sidewalks are provided within a specific range from the reference location Y may be determined as dispatch candidate locations and presented to the user. This makes it easy to limit the designation of the dispatch location of the mobile object 108 (such as a taxi) to safe roads that have sidewalks. Also, roads that have no steps in the sidewalks within a specific range from the reference location Y may be determined as dispatch candidate locations and presented to the user. This makes it easy to limit the designation of the dispatch location of the mobile object 108 (such as a delivery vehicle) to roads with no steps in the sidewalks.

Also, the dispatch information may be information related to traffic congestion. For example, information about roads with heavy traffic may be collected through the communication unit 18 and utilized as dispatch information. More specifically, roads that have light traffic within a specific range from the reference location Y may be determined as dispatch candidate locations and presented to the user. Also, information related to traffic congestion and other dispatch information may be used in combination. For example, locations that can be entered by the mobile object 108 and that are roads with light traffic within a specific range from the reference location Y may be determined as dispatch candidate locations and presented to the user.

Also, the dispatch information may be information related to weather. For example, information related to the weather in various locations may be collected through the communication unit 18 and utilized as dispatch information. More specifically, locations that are within a specific range from the reference location Y and where the amount of rainfall is at or below a specific reference value may be determined as dispatch candidate locations and presented to the user. Also, a combination of information related to weather and other dispatch information may be used. For example, as information related to the environment, information related to places where the rain is tolerable may be utilized as dispatch information, and for areas that are within a specific range from the reference location Y and where the rainfall is at or above a specific reference value, places where the rain is tolerable may be determined as dispatch candidate locations and presented to the user.

Also, the dispatch information may be changed according to the size of the mobile object 108. For example, dispatch information may be prepared for vehicles 108 of various sizes, and the dispatch information may be switched according to the size of the mobile object 108 that is to be dispatched. For example, when a location where the mobile object 108 cannot stop is used as dispatch information, no-parking locations where the vehicle cannot stop are registered in the storage unit 12 for each size of the mobile object 108 (motorcycles, compact cars, midsize cars, light trucks, medium trucks, heavy trucks, etc.), and the dispatch candidate locations may be determined by selecting the dispatch information corresponding to the size of the mobile object 108 to be dispatched. As a specific example, the dispatch information may be selected according to the size of the taxi the user wants to have dispatched or the size of the vehicle loaded with the cargo to be delivered to the user, and locations where a vehicle of this size can stop may be determined as the dispatch candidate locations and presented to the user.

It is also possible to vary the dispatch information with the time of day. For example, there are situations when locations where the mobile object 108 cannot stop (no-parking locations, no-stopping locations, etc.) change with the time of day, so locations where the mobile object 108 can stop may be registered as dispatch information according to time ranges, dispatch information corresponding to the time at which the reference location Y was designated may be selected, and locations where the mobile object 108 can stop at said time within a specific range from the reference location Y may be determined as the dispatch candidate locations and presented to the user. Also, information about roads that are dark at night or roads with no streetlights may be registered as dispatch information, between sunrise and sunset dispatch candidate locations may be determined regardless of this dispatch information, and between sunset and sunrise dispatch candidate locations may be determined by excluding roads that are dark at night or roads with no streetlights.

Also, dispatch information may be information obtained from a dispatch location Z designated in the past. For example, as shown in FIG. 13, the processor 10 stores dispatch information Z designated in the past for each user, as dispatch location history information in the storage unit 12 in association with user IDs. This dispatch location history information is then utilized as dispatch information. More specifically, the last dispatch locations Z designated by each user are registered, and this information is utilized as dispatch information. Consequently, the last dispatch locations Z designated by each user can be determined as dispatch candidate locations and presented to the user. Also, the average locations of the coordinates of the last dispatch locations Z designated by each user may be registered, and this information may be utilized as dispatch information. This allows the average location of the past dispatch locations Z for each user to be presented to the user as dispatch candidate locations.

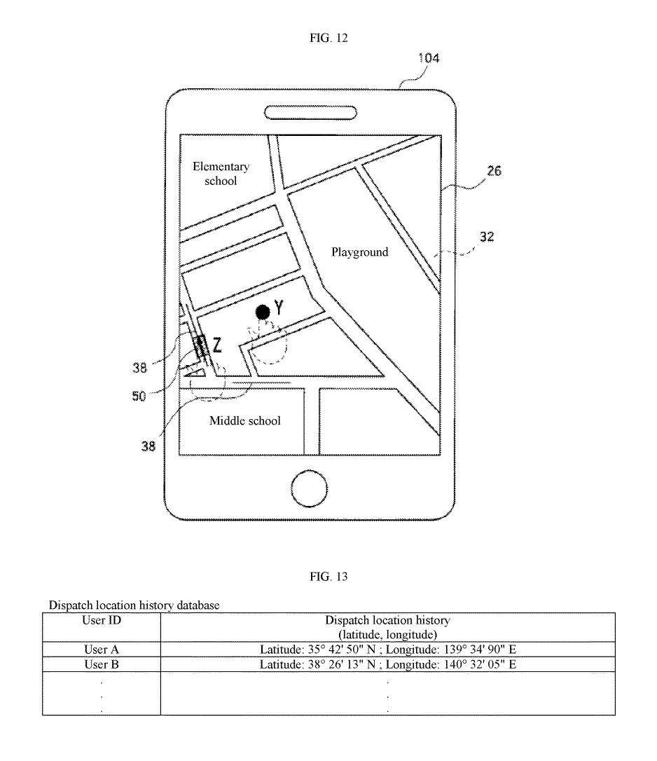

Also, the configuration may be such that the orientation of the mobile object 108 at the time of dispatch can be designated in addition to the dispatch location Z. For example, if the mobile object 108 is a road-going vehicle, it may have to drive along a predetermined side of the road, such as with left-hand traffic or right-hand traffic. In view of this, the it is preferable to be able to designate the direction of the mobile object 108 so that it can be dispatched by taking into account the side on which it is easier to board the mobile object 108, or the side on which it is easier to unload the cargo (the side of the mobile object 108 with a cargo door). In view of this, as shown in FIG. 12, an icon 50 indicating the orientation of the mobile object 108 may be displayed on the map when the dispatch location Z is being designated. In this case, it is preferable if the orientation of the mobile object 108 can be designated by the user. For example, the user may switch the orientation of the mobile object 108 along the road (indicated by the arrow of the icon 50 in FIG. 12) every time he double-taps the icon 50. Information about the orientation of the mobile object 108 is sent from the user terminal 104 to the host computer 102. It is also sent from the host computer 102 to the mobile object 108. Consequently, the mobile object 108 can be moved to the dispatch location in the designated orientation.

The processing may also determine the dispatch candidate locations from their relationship with the destination of the mobile object 108, in addition to the reference location Y. In such a case, the input unit 24 can be used to designate the destination of the mobile object 108 along with the reference location Y. For example, if the mobile object 108 is a taxi, the user may designate as the destination of the mobile object 108 the location to which the taxi goes when the user gets in. The processor 20 may perform a route search from the reference location Y to the destination on the basis of the relationship between the reference location Y and the destination, and may choose a dispatch candidate location that is along the obtained route and is within a specific range from the reference location Y. Also, locations that will not result in a roundabout route to the destination (for example, a location that will result in the shortest distance to the destination, or a location that will result in the shortest arrival time at the destination) may be determined as dispatch candidate locations on the basis of the relationship between the reference location Y and the destination.

The examples of dispatch information given above may also be used in suitable combinations. When using a combination of a plurality of dispatch information, locations that satisfy all of the specific conditions for the plurality of dispatch information may be determined as dispatch candidate locations. Also, a priority ranking may be established for the plurality of dispatch information, dispatch information may be selected in the order of highest priority, and locations that satisfy the specific conditions for the selected dispatch information may be determined as dispatch candidate locations. In this case, if there is a location that satisfies the specific conditions for the dispatch information with the highest priority, that location is determined as a dispatch candidate location, and if there is no location that satisfies these conditions, it may be determined whether or not there is a location that satisfies the specific conditions for the dispatch information with the next highest priority. This processing can be repeated in the order of priority to determine the dispatch candidate locations on the basis of a plurality of dispatch information, and present the results to the user.

Also, some or all of the processing described in this embodiment as being performed by the host computer 102 may instead be performed by the user terminal 104, and some or all of the processing described as being performed by the user terminal 104 may instead be performed by the host computer 102.

### Description of the Reference Codes

10 processor

12 storage unit

14 input unit

16 output unit

18 communication unit

20 processor

22 storage unit

24 input unit

26 output unit

28 communication unit

30 map database

32 map

34, 36 dispatch information

38 dispatch candidate location

40 specific range

50 icon

100 dispatch system

102 host computer

104 user terminal

106 information communication network

108 mobile object

What is claimed is:

1. A placement system for mobile objects comprising a user terminal and a host computer connected so as to be able to exchange information with the user terminal, the system comprising:
a storage configured to store dispatch information related to factors that influence the dispatch of mobile objects in association with locations on a map;
a map display configured to display the map on the user terminal;
the user terminal configured to receive the input of a location on the map, and to refer to the location information and determine dispatch candidate locations that are candidates for dispatching a mobile object based on the location of the vehicles on the map inputted by the user terminal; and
a display configured to display the dispatch candidate locations on the map displayed on the user terminal.

2. The placement system for mobile objects according to claim 1, further comprising:
the user terminal configured to receive a designation of a mobile object dispatch location from the map on which the dispatch candidate locations are displayed, and wherein information about the dispatch location is provided to a mobile object.

3. The placement system for mobile objects according to claim 2, wherein the dispatch information includes information obtained from the dispatch locations designated in the past.

4. The placement system for mobile objects according to claim 1,
wherein the dispatch information includes at least one of the following: road conditions, environment information, traffic information, weather information, and information about the mobile objects.

5. The placement system for mobile objects according to claim 1,
wherein the dispatch information is changed according to the time of day.

6. The placement system for mobile objects according to claim 1,
wherein the user terminal receives a designation of the travel direction of a mobile object at the dispatch location, and
information about the travel direction is provided to the mobile object.

7. A user terminal comprising:
a map display configured to display a map;
wherein the user terminal is configured to receive the input of a location on the map, and
refer to dispatch information that influences the dispatch of vehicles in association with locations on the map, and determine dispatch candidate locations that are candidates for dispatching a vehicle based on the location of the vehicles on the map as inputted via the user terminal; and
a display configured to display the dispatch candidate locations on the map.

8. A non-transitory computer readable medium having instructions for performing dispatch of vehicles, including a processor and a storage configured to store dispatch information that influences the dispatch of vehicles in association with locations on a map, the instructions comprising:
displaying a map;
receiving the input of a location on the map;
referring to dispatch information that influences the dispatch of vehicles in association with locations on the map, and determining dispatch candidate locations that are candidates for dispatching a vehicle based on the location of the vehicles on the map as inputted by the receiving; and
displaying the dispatch candidate locations on the map.
